(19) United States
(12) Patent Application Publication
(10) Pub. No.: US 2002/0022151 A1
(43) Pub. Date: Feb. 21, 2002

(54) Organic electroluminescent device

(76) Inventors: Hitoshi Ishikawa, Tokyo (JP); Satoru Toguchi, Tokyo (JP); Hiroshi Tada, Tokyo (JP); Atsushi Oda, Tokyo (JP)

Correspondence Address: ROSENMAN & COLIN LLP, 575 MADISON AVENUE, NEW YORK, NY, 10022-2585, US

(21) Appl. No.: 09/911,003

(22) Filed: Jul. 23, 2001

(30) Foreign Application Priority Data
Jul. 25, 2000 (JP) 2000-224056
Jul. 25, 2000 (JP) 2000-223975

(51) Int. Cl. H05B 33/12

(52) U.S. Cl. 428/690; 428/917; 313/504; 313/506

(57) ABSTRACT

A high-brightness and long-life organic electroluminescent device, which employs, as a material for constituting an organic thin film interposed between an anode and a cathode, a specific fluoranthene compound represented by the following general formula [I] or a biphenylene compound represented by the following general formula [II]:

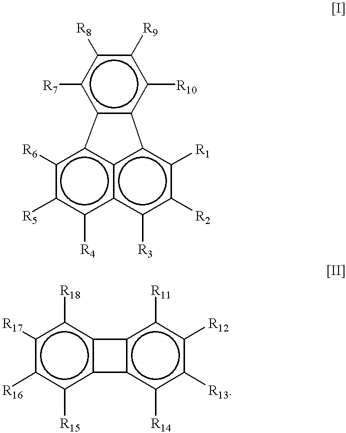

wherein each of R₁-R₁₀ and R₁l-R₁₈ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group. At least one of R₁-R₁₀ is a diarylamino group represented by —NAr₁Ar₂ (Ar₁ and Ar₂ are each independently a substituted or non-substituted aryl group with 6-20 carbon atoms). Two of R₁-R₁₀ may form a ring. At least one of R₁₁-R₁₈ is a diarylamino group represented by —NAr₁₁Ar₁₂ (Ar₁₁ and Ar₁₂ each independently represent a substituted or non-substituted aryl group with 6-20 carbon atoms). Two of R₁₁-R₁₈ may form a ring.

### BACKGROUND OF THE INVENTION

1. Field of the Invention

The present invention relates to an organic electroluminescent device with excellent luminescent properties.

2. Description of the Related Art

An organic electroluminescent device (which will hereinafter be called “organic EL device”) is alight-emitting device which makes use of the principle that when an electric field is applied, a fluorescent material emits light in response to the charge recombination of holes injected from an anode and electrons injected from a cathode. After C. W. Tang et al. of Eastman Kodak Company reported a low-voltage-driven organic EL device using a double layered structure (C. W. Tang, S. A. Vanslyke, Applied Physics Letters, Vol. 51, 913 (1987) and the like), studies on an organic EL device have been briskly carried out. Tang et al. reported an organic EL device using tris(8-hydroxyquinolinol aluminum) in a light-emitting layer and a triphenyldiamine derivative in a hole-transporting layer. This stacked structure gives such advantages as an improvement in the injection efficiency of holes into the light-emitting layer; and confinement of the excitons into the light-emitting layer.

A double layered structure composed of a hole-injecting and transporting layer and an electron-transporting and light-emitting layer or a triple layered structure composed of a hole-injecting and transporting layer, a light-emitting layer and an electron-injecting and transporting layer is well known as an organic EL device. In order to increase the recombination efficiency of injected holes and electrons, various improvements in the device structure or fabrication process have been introduced to such multi-layered devices.

As a hole-transporting material, triphenyl amine derivatives and aromatic diamine derivatives such as 4,4′,4″-tris(3-methylphenylphenylamino)-triphenyl amine which is a star burst molecule and N,N′-diphenyl-N,N′-bis(3-methylphenyl)-[1,1′-biphenyl]-4,4′-diamine are well known (for example, Patent Publications JP-A-8-20771, JP-A-8-40995, JP-A-8-40997, JP-A-8-53397, and JP-A-8-87122). As an electron-transporting material, oxadiazole derivatives, triazole derivatives and the like are well known.

Chelate complexes such as tris(8-quinolinolate)aluminum complex, coumarin derivatives, tetraphenylbutadiene derivatives, bisstyrylarylene derivatives, oxadiazole derivatives and the like are known as light emitting materials. Since various color lights in a visible region from blue to red are obtained from these light-emitting materials, there is increased expectation for industrialization of a full color organic EL device (refer to, e.g., JP-A-8-239655, JP-A-7-138561, and JP-A-3-200889).

Some organic EL devices with high luminance and long life have been reported or disclosed in recent years. However, the luminance and the life of such EL devices are not necessarily sufficient for practical use. Under such circumstances, there is an increasing demand for development of the materials capable of providing an organic EL device with high performance.

### SUMMARY OF THE INVENTION

An object of the present invention is to provide a high-brightness and long-life organic EL device.

The inventors have intensively studied and found as a result that a compound having a fluoranthene moiety is effective as a material for constituting an organic EL device. This finding finally leads them to complete the present invention, which provides the following organic EL devices.

According to a first aspect of the present invention, there is provided an organic electroluminescent device comprising one or more organic thin film layer(s) containing a luminescent layer placed between an anode and a cathode, wherein at least one layer of the organic thin film contains a compound represented by the following general formula [I] in the form of a single substance or a mixture containing the same:

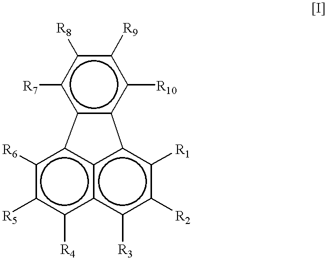

wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

At least one of Ar₁and Ar₂ in the compound represented by the general formula [I] may have a substituted or non-substituted styryl group as a substituent.

The organic thin film may have at least a hole-transporting layer, the hole-transporting layer containing the compound represented by the general formula [I] in the form of a single substance or a mixture containing the same.

The organic thin film may have at least a hole-transporting layer, the hole-transporting layer containing the compound represented by the general formula [I] in the form of a single substance or a mixture containing the same, and at least one of Ar₁ and Ar₂ in the compound represented by the following general formula [I] may have a substituted or non-substituted styryl group as a substituent.

The organic thin film may have at least an electron-transporting layer, the electron-transporting layer containing the compound represented by the general formula [I] in the form of a single substance or a mixture containing the same.

The organic thin film may have at least an electron-transporting layer, the electron-transporting layer containing the compound represented by the general formula [I] in the form of a single substance or a mixture containing the same, and at least one of Ar₁ and Ar₂ in the compound represented by the general formula [I] may have a substituted or non-substituted styryl group as a substituent.

According to a second aspect of the present invention, there is provided an organic electroluminescent device comprising at least an anode, an organic luminescent zone and a cathode as constituents, wherein the luminescent zone being formed one or more organic thin film layer(s), characterized in that luminescent zone is adjacent to the anode, and a layer adjacent to the anode of the organic layer(s) forming the luminescent zone contains a compound expressed in following general formula [I] in the form of a single substance or a mixture containing the same:

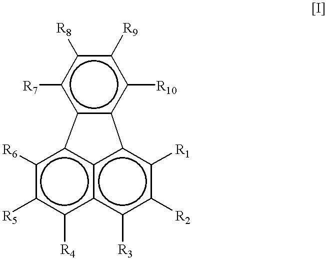

wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

At least one of Ar₁ and Ar₂ in the compound represented by the general formula [I] may have a substituted or non-substituted styryl group as a substituent.

According to a third aspect of the present invention, there is provided an organic electroluminescent device comprising one or more organic thin film layer(s) containing a luminescent layer placed between an anode and a cathode, wherein at least one layer of the organic thin film contains a compound represented by the following general formula [II] in the form of a single substance or a mixture containing the same:

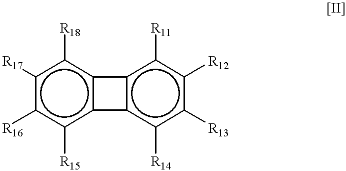

wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂(Ar₁ and Ar₂ each independently represent a substituted or non-substituted aryl group having 6-20 carbon atoms); and two of R₁-R₁₀ may form a ring.

At least one of Ar₁l and Ar₁₂ in the compound represented by the general formula [II] may have a substituted or non-substituted styryl group as a substituent. The organic thin film may have at least a hole-transporting layer, the hole-transporting layer containing the compound represented by the general formula [II] in the form of a single substance or a mixture containing the same.

The organic thin film may have at least a hole-transporting layer, the hole-transporting layer containing the compound represented by the general formula [II] in the form of a single substance or a mixture containing the same, and at least one of Ar₁₁ and Ar₁₂ in the compound represented by the general formula [II] may have a substituted or non-substituted styryl group as a substituent.

The organic thin film may include at least an electron-transporting layer, the electron-transporting layer containing the compound represented by the general formula [II] in the form of a single substance or a mixture containing the same.

The organic thin film may include at least an electron-transporting layer, the electron-transporting layer containing the compound represented by the general formula [II] in the form of a single substance or a mixture containing the same, and at least one of Ar₁₁ and Ar₁₂ in the compound represented by the following general formula [II] may have a substituted or non-substituted styryl group as a substituent.

According to a fourth aspect of the present invention, there is provided an organic electroluminescent device comprising at least an anode, an organic luminescent zone and a cathode as constituents, wherein the luminescent zone being formed one or more organic thin film layer(s), characterized in that luminescent zone is adjacent to the anode, and a layer adjacent to the anode of the organic layer(s) forming the luminescent zone contains a compound expressed in following general formula [I] in the form of a single substance or a mixture containing the same:

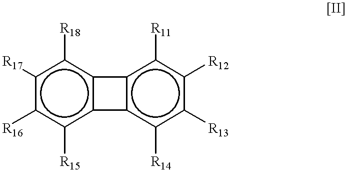

wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

At least one of Ar₁₁ and Ar₁₂ in the compound represented by the general formula [II] may have a substituted or non-substituted styryl group as a substituent.

Other features and advantages of the invention will be apparent from the following description of the preferred embodiments thereof.

### BRIEF DESCRIPTION OF THE DRAWINGS

The present invention will be more fully understood from the following detailed description with reference to the accompanying drawings in which:

FIG. 1 is a cross-sectional view showing an electroluminescent device according to one mode of embodiment of the present invention;

FIG. 2 is a cross-sectional view showing an electroluminescent device according to another mode of embodiment of the present invention;

FIG. 3 is a cross-sectional view showing an electroluminescent device according to still another mode of embodiment of the present invention; and

FIG. 4 is a cross-sectional view showing an electroluminescent device according to still another mode of embodiment of the present invention.

### DETAILED DESCRIPTION OF THE PREFERRED MODES OF EMBODIMENT

Preferred modes of embodiment of the present invention will be described below in detail.

A compound that is employed between an anode and a cathode of an EL device of the present invention is a compound that has a structure represented by the general formula [I]. In this formula, R₁-R₁₀ each independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group. Two of R₁-R₁₀ may form a ring.

At least one of R₁-R₁₀ is a diarylamino group represented by —NAr₁Ar₂ (Ar₁ and Ar₂ each independently represent a substituted or non-substituted aryl group with 6-20 carbon atoms). In a suitable compound among the compounds represented by the general formula [I], at least one of Ar₁ and Ar₂ includes a substituted or non-substituted styryl group as a substituent.

In addition, a compound that is employed between an anode and a cathode of an EL device of the present invention is a compound that has a structure represented by the general formula [II]. In this formula, each of R₁₁-R₁₈ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group. Two of R₁₁-R₁₈ may form a ring.

At least one of R₁₁-R₁₈ is a diarylamino group represented by —NAr₁₁Ar₁₂ (each of Ar₁₁ and Ar₁₂ independently represent a substituted or non-substituted aryl group with 6-20 carbon atoms). In a suitable compound among the compounds represented by the general formula [II], at least one of Ar₁₁ and Ar₁₂includes a substituted or non-substituted styryl group as a substituent.

In the formulae [I] and [II], the halogen atom includes fluorine, chlorine, bromine and iodine atoms.

In the formulae [I] and [II], the substituted or non-substituted amino group is represented by —NX₁X₂. each of X₁ and X₂ include independently a hydrogen atom, methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro t-butyl group, 1,2,3-trinitropropyl group, phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 4-styrylphenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group, 2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthroline-2-yl group, 1,7-phenanthroline-3-yl group, 1,7-phenanthroline-4-yl group, 1,7-phenanthroline-5-yl group, 1,7-phenanthroline-6-yl group, 1,7-phenanthroline-8-yl group, 1,7-phenanthroline-9-yl group, 1,7-phenanthroline-10-yl group, 1,8-phenanthroline-2-yl group, 1,8-phenanthroline-3-yl group, 1,8-phenanthroline-4-yl group, 1,8-phenanthroline-5-yl group, 1,8-phenanthroline-6-yl group, 1,8-phenanthroline-7-yl group, 1,8-phenanthroline-9-yl group, 1,8-phenanthroline-10-yl group, 1,9-phenanthroline-2-yl group, 1,9-phenanthroline-3-yl group, 1,9-phenanthroline-4-yl group, 1,9-phenanthroline-5-yl group, 1,9-phenanthroline-6-yl group, 1,9-phenanthroline-7-yl group, 1,9-phenanthroline-8-yl group, 1,9-phenanthroline-10-yl group, 1,10-phenanthroline-2-yl group, 1,10-phenanthroline-3-yl group, 1,10-phenanthroline-4-yl group, 1,10-phenanthroline-5-yl group, 2,9-phenanthroline-1-yl group, 2,9-phenanthroline-3-yl group, 2,9-phenanthroline-4-yl group, 2,9-phenanthroline-5-yl group, 2,9-phenanthroline-6-yl group, 2,9-phenanthroline-7-yl group, 2,9-phenanthroline-8-yl group, 2,9-phenanthroline-10-yl group, 2,8-phenanthroline-1-yl group, 2,8-phenanthroline-3-yl group, 2,8-phenanthroline-4-yl group, 2,8-phenanthroline-5-yl group, 2,8-phenanthroline-6-yl group, 2,8-phenanthroline-7-yl group, 2,8-phenanthroline-9-yl group, 2,8-phenanthroline-10-yl group, 2,7-phenanthroline-1-yl group, 2,7-phenanthroline-3-yl group, 2,7-phenanthroline-4-yl group, 2,7-phenanthroline-5-yl group, 2,7-phenanthroline-6-yl group, 2,7-phenanthroline-8-yl group, 2,7-phenanthroline-9-yl group, 2,7-phenanthroline-10-yl group, 1-phenazinyl group, 2-phenazinyl group, 1-phenothiazinyl group, 2-phenothiazinyl group, 3-phenothiazinyl group, 4-phenothiazinyl group, 1-phenoxazinyl group, 2-phenoxazinyl group, 3-phenoxazinyl group, 4-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrole-1-yl group, 2-methylpyrrole-3-yl group, 2-methylpyrrole-4-yl group, 2-methylpyrrole-5-yl group, 3-methylpyrrole-1-yl group, 3-methylpyrrole-2-yl group, 3-methylpyrrole-4-yl group, 3-methylpyrrole-5-yl group, 2-t-butylpyrrole-4-yl group, 3-(2-phenylpropyl)pyrrole-1-yl group, 2-methyl-1-indolyl group, 4-methyl-1-indolyl group, 2-methyl-3-indolyl group, 4-methyl-3-indolyl group, 2-t-butyl 1-indolyl group, 4-t-butyl 1-indolyl group, 2-t-butyl 3-indolyl group, and 4-t-butyl 3-indolyl group.

In the formulae [I] and [II], the substituted or non-substituted alkyl group includes methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethylgroup, 1-chloroethylgroup, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group 2,3-dicyano t-butyl group, 1,2,3-tricyanopropyl group, nitromethyl group, 1-nitroethyl group, 2-nitroethyl group, 2-nitroisobutyl group 1,2-dinitroethyl group and 1,3-dinitroisopropyl group, 2,3-dinitro t-butyl group, and 1,2,3-trinitropropyl group.

In the formulae [I] and [II], the substituted or non-substituted alkenyl group includes vinyl group, allyl group, 1-butenyl group, 2-butenyl group, 3-butenyl group, 1,3-butandienyl group, 1-methylvinyl group, styryl group, 4-diphenylaminostyryl group, 4-di-p-tolylaminostyryl group, 4-di-m-tolylaminostyryl group, 2,2-diphenylvinyl group, 1,2-diphenylvinyl group, 1-methylallyl group, 1,1-dimethylallyl group, 2-methylallyl group, 1-phenylallyl group, 2-phenylallyl group, 3-phenylallyl group, 3,3-diphenylallyl group, 1,2-dimethylallyl group, 1-phenyl-1-butenyl group, and 3-phenyl-1-butenyl group.

In the formulae [I] and [II], the substituted or non-substituted cycloalkyl group includes cyclopropyl group, cyclobutyl group, cyclopentyl group, cyclohexyl group, and 4-methylcyclohexyl group.

In the formulae [I] and [II], the substituted or non-substituted alkoxy group is a group represented by -OY. Y includes ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino t -butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro t-butyl group, and

1,2,3-trinitropropyl group.

In the formulae [I] and [II], the substituted or non-substituted aromatic hydrocarbon group includes phenyl group, 1-naphthyl group., 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, and 4′-t-butyl-p-terphenyl-4-yl group.

In the formulae [I] and [II], the substituted or non-substituted aromatic heterocycle group includes 1-pyrrolyl group, 2-pyrrolyl group, 3-pyrrolyl group, pyrazinyl group, 2-pyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-isoindolyl group, 2-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthroline-2-yl group, 1,7-phenanthroline-3-yl group, 1,7-phenanthroline-4-yl group, 1,7-phenanthroline-5-yl group, 1,7-phenanthroline-6-yl group, 1,7-phenanthroline-8-yl group, 1,7-phenanthroline-9-yl group, 1,7-phenanthroline-10-yl group, 1,8-phenanthroline-2-yl group, 1,8-phenanthroline-3-yl group, 1,8-phenanthroline-4-yl group, 1,8-phenanthroline -5-yl group, 1,8-phenanthroline-6-yl group, 1,8-phenanthroline-7-yl group, 1,8-phenanthroline-9-yl group, 1,8-phenanthroline-10-yl group, 1,9-phenanthroline-2-yl group, 1,9-phenanthroline-3-yl group, 1,9-phenanthroline-4-yl group, 1,9-phenanthroline-5-yl group, 1,9-phenanthroline-6-yl group, 1,9-phenanthroline-7-yl group, 1,9-phenanthroline-8-yl group, 1,9-phenanthroline-10-yl group, 1,10-phenanthroline-2-yl group, 1,10-phenanthroline-3-yl group, 1,10-phenanthroline-4-yl group, 1,10-phenanthroline-5-yl group, 2,9-phenanthroline-1-yl group, 2,9-phenanthroline-3-yl group, 2,9-phenanthroline -4-yl group, 2,9-phenanthroline-5-yl group, 2,9-phenanthroline-6-yl group, 2,9-phenanthroline-7-yl group, 2,9-phenanthroline-8-yl group, 2,9-phenanthroline-10-yl group, 2,8-phenanthroline-1-yl group, 2,8-phenanthroline-3-yl group, 2,8-phenanthroline-4-yl group, 2,8-phenanthroline-5-yl group, 2,8-phenanthroline-6-yl group, 2,8-phenanthroline-7-yl group, 2,8-phenanthroline-9-yl group, 2,8-phenanthroline-10-yl group, 2,7-phenanthroline-1-yl group, 2,7-phenanthroline-3-yl group, 2,7-phenanthroline-4-yl group, 2,7-phenanthroline-5-yl group, 2,7-phenanthroline-6-yl group, 2,7-phenanthroline-8-yl group, 2,7-phenanthroline-9-yl group, 2,7-phenanthroline-10-yl group, 1-phenazinyl group, 2-phenazinyl group, 1-phenothiazinyl group, 2-phenothiazinyl group, 3-phenothiazinyl group, 4-phenothiazinyl group, 10-phenothiazinyl group, 1-phenoxazinyl group, 2-phenoxazinyl group, 3-phenoxazinyl group, 4-phenoxazinyl group, 10-phenoxazinyl group, 2-oxazolyl group, 4-oxazolyl group, 5-oxazolyl group, 2-oxadiazolyl group, 5-oxadiazolyl group, 3-furazanyl group, 2-thienylgroup, 3-thienylgroup, 2-methylpyrrole-1-yl group, 2-methylpyrrole-3-yl group, 2-methylpyrrole-4-yl group, 2-methylpyrrole-5-yl group, 3-methylpyrrole-1-yl group, 3-methylpyrrole-2-yl group, 3-methylpyrrole-4-yl group, 3-methylpyrrole-5-yl group, 2-t-butylpyrrole-4-yl group, 3-(2-phenylpropyl)pyrrole-1-yl group, 2-methyl-l-indolyl group, 4-methyl-1-indolyl group, 2-methyl-3-indolyl group, 4-methyl-3-indolyl group, 2-t-butyl 1-indolyl group, 4-t-butyl 1-indolyl group, 2-t-butyl 3-indolyl group, and 4-t-butyl 3-indolyl group.

In the formulae [I] and [II], the substituted or non-substituted aralkyl group includes benzyl group, 1-phenylethyl group, 2-phenylethyl group, 1-phenylisopropyl group, 2-phenylisopropyl group, phenyl-t-butyl group, α-naphthylmethyl group, 1-α-naphthylethyl group, 2-α-naphthylethyl group, 1-α-naphthylisopropyl group, 2-α-naphthylisopropyl group, β-naphthylmethyl group, 1-β-naphthylethyl group, 2-β-naphthylethyl group, 1-β-naphthylisopropyl group, 2-β-naphthylisopropyl group, 1-pyrrolylmethyl group, 2-(1-pyrrolyl)ethyl group, p-methylbenzyl group, m-methylbenzyl group, o-methylbenzyl group, p-chlorobenzyl group, m-chlorobenzyl group, o-chlorobenzyl group, p-bromobenzyl group, m-bromobenzyl group, o-bromobenzyl group, p-iodobenzyl group, m-iodobenzyl group, o-iodobenzyl group, p-hydroxybenzyl group, m-hydroxybenzyl group, o-hydroxybenzyl group, p-aminobenzyl group, m-aminobenzyl group, o-aminobenzyl group, p-nitrobenzyl group, m-nitrobenzyl group, o-nitrobenzyl group, p-cyanobenzyl group, m-cyanobenzyl group, o-cyanobenzyl group, 1-hydroxy-2-phenylisopropyl group, and 1-chloro-2-phenylisopropyl group.

In the formulae [I] and [II], the substituted or non-substituted aryloxy group is represented by -OZ. Z includes phenyl group, 1-naphthyl group, 2-naphthyl group, 1-anthryl group, 2-anthryl group, 9-anthryl group, 1-phenanthryl group,2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenylyl group, 4″-t-butyl-p-terphenyl-4-yl group,2-pyrrolyl group, 3-pyrrolyl group, pyrazinyl group, 2-pyridinyl group, 3-pyridinyl group, 4-pyridinyl group, 2-indolyl group, 3-indolyl group, 4-indolyl group, 5-indolyl group, 6-indolyl group, 7-indolyl group, 1-isoindolyl group, 3-isoindolyl group, 4-isoindolyl group, 5-isoindolyl group, 6-isoindolyl group, 7-isoindolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthroline-2-yl group, 1,7-phenanthroline-3-yl group, 1,7-phenanthroline-4-yl group, 1,7-phenanthroline-5-yl group, 1,7-phenanthroline-6-yl group, 1,7-phenanthroline-8-yl group, 1,7-phenanthroline-9-yl group, 1,7-phenanthroline-10-yl group, 1,8-phenanthroline-2-yl group, 1,8-phenanthroline-3-yl group, 1,8-phenanthroline-4-yl group, 1,8-phenanthroline-5-yl group, 1,8-phenanthroline-6-yl group, 1,8-phenanthroline-7-yl group, 1,8-phenanthroline-9-yl group, 1,8-phenanthroline-10-yl group, 1,9-phenanthroline-2-yl group, 1,9-phenanthroline-3-yl group, 1,9-phenanthroline-4-yl group, 1,9-phenanthroline-5-yl group, 1,9-phenanthroline-6-yl group, 1,9-phenanthroline-7-yl group, 1,9-phenanthroline-8-yl group, 1,9-phenanthroline-10-yl group, 1,10-phenanthroline-2-yl group, 1,10-phenanthroline-3-yl group, 1,10-phenanthroline-4-yl group, 1,10-phenanthroline-5-yl group, 2,9-phenanthroline-1-yl group, 2,9-phenanthroline-3-yl group, 2,9-phenanthroline-4-yl group, 2,9-phenanthroline-5-yl group, 2,9-phenanthroline-6-yl group, 2,9-phenanthroline-7-yl group, 2,9-phenanthroline-8-yl group, 2,9-phenanthroline-10-yl group, 2,8-phenanthroline-1-yl group, 2,8-phenanthroline-3-yl group, 2,8-phenanthroline-4-yl group, 2,8-phenanthroline-5-yl group, 2,8-phenanthroline-6-yl group, 2,8-phenanthroline-7-yl group, 2,8-phenanthroline-9-yl group, 2,8-phenanthroline-10-yl group, 2,7-phenanthroline-1-yl group, 2,7-phenanthroline-3-yl group, 2,7-phenanthroline-4-yl group, 2,7-phenanthroline-5-yl group, 2,7-phenanthroline-6-yl group, 2,7-phenanthroline-8-yl group, 2,7-phenanthroline-9-yl group, 2,7-phenanthroline-1O-yl group, 1-phenazinyl group, 2-phenazinyl group, 1-phenothiazinyl group, 2-phenothiazinyl group, 3-phenothiazinyl group, 4-phenothiazinyl group, 1-phenoxazinyl group, 2-phenoxazinyl group, 3-phenoxazinyl group, 4-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrole-1-yl group, 2-methylpyrrole-3-yl group, 2-methylpyrrole-4-yl group, 2-methylpyrrole-5-yl group, 3-methylpyrrole-1-yl group, 3-methylpyrrole-2-yl group, 3-methylpyrrole-4-yl group, 3-methylpyrrole-5-yl group, 2-t-butylpyrrole-4-yl group, 3-(2-phenylpropyl)pyrrole-1-yl group, 2-methyl-1-indolyl group, 4-methyl-1-indolyl group, 2-methyl-3-indolyl group, 4-methyl-3-indolyl group, 2-t-butyl 1-indolyl group, 4-t-butyl 1-indolyl group, 2-t-butyl 3-indolyl group, and 4-t-butyl 3-indolyl group.

In the formulae [I] and [II], the substituted or non-substituted alkoxycarbonyl group is represented by —COOY. Y includes methyl group, ethyl group, propyl group, isopropyl group, n-butyl group, s-butyl group, isobutyl group, t-butyl group, n-pentyl group, n-hexyl group, n-heptyl group, n-octyl group, hydroxymethyl group, 1-hydroxyethyl group, 2-hydroxyethyl group, 2-hydroxyisobutyl group, 1,2-dihydroxyethyl group, 1,3-dihydroxyisopropyl group, 2,3-dihydroxy-t-butyl group, 1,2,3-trihydroxypropyl group, chloromethyl group, 1-chloroethyl group, 2-chloroethyl group, 2-chloroisobutyl group, 1,2-dichloroethyl group, 1,3-dichloroisopropyl group, 2,3-dichloro-t-butyl group, 1,2,3-trichloropropyl group, bromomethyl group, 1-bromoethyl group, 2-bromoethyl group, 2-bromoisobutyl group, 1,2-dibromoethyl group, 1,3-dibromoisopropyl group, 2,3-dibromo t-butyl group, 1,2,3-tribromopropyl group, iodomethyl group, 1-iodoethyl group, 2-iodoethyl group, 2-iodoisobutyl group, 1,2-diiodoethyl group, 1,3-diiodoisopropyl group, 2,3-diiodo t-butyl group, 1,2,3-triiodopropyl group, aminomethyl group, 1-aminoethyl group, 2-aminoethyl group, 2-aminoisobutyl group, 1,2-diaminoethyl group, 1,3-diaminoisopropyl group, 2,3-diamino t-butyl group, 1,2,3-triaminopropyl group, cyanomethyl group, 1-cyanoethyl group, 2-cyanoethyl group, 2-cyanoisobutyl group, 1,2-dicyanoethyl group, 1,3-dicyanoisopropyl group, 2,3-dicyano t-butyl group, 1,2,3-tricyanopropyl group, nitromethyl group, 1-nitroethyl group, 2-nitroethyl group, 2-nitroisobutyl group, 1,2-dinitroethyl group, 1,3-dinitroisopropyl group, 2,3-dinitro t-butyl group, and 1,2,3-trinitropropyl group. In the formulae [I] and [II], the aryl group with 6-20 carbon atoms includes a phenyl group, naphthyl group, anthryl group, phenanthryl group, naphthacenyl group and pyrenyl group.

Substituents for the aryl group and the above-described styryl group include a halogen atom, hydroxyl group, the above-described substituted or non-substituted amino group, nitro group, cyano group, the above-described substituted or non-substituted alkyl group, the above-described substituted or non-substituted alkenyl group, the above-described substituted or non-substituted cycloalkyl group, the above-described substituted or non-substituted alkoxy group, the above-described substituted or non-substituted aromatic hydrocarbon group, the above-described substituted or non-substituted aromatic heterocycle group, the above-described substituted or non-substituted aralkyl group, the above-described substituted or non-substituted aryloxy group, the above-described substituted or non-substituted alkoxycarbonyl group and carboxyl group.

In the formulae [I] and [II], a divalent group that forms a ring includes a tetramethylene group, pentamethylene group, hexamethylene group, diphenylmethane-2,2′-diyl group, diphenylethane-3,3′-diyl group and diphenylpropane-4,4-diyl group.

The compound represented by the general formula [I] in the present invention can be synthesized by known methods in the art. For example, a fluoranthene compound having a diphenylamino group can be synthesized from an Ullmann reaction of an amine compound having a fluoranthene skeleton with an aromatic halogen compound or of a halogen compound having a fluoranthene skeleton with an aromatic amine. A styryl derivative can be synthesized using the publicly known Wittig-Horner reaction in the art.

The compounds represented by the general formula [I] in the present invention are shown below with reference to examples that are not intended to limit the invention.

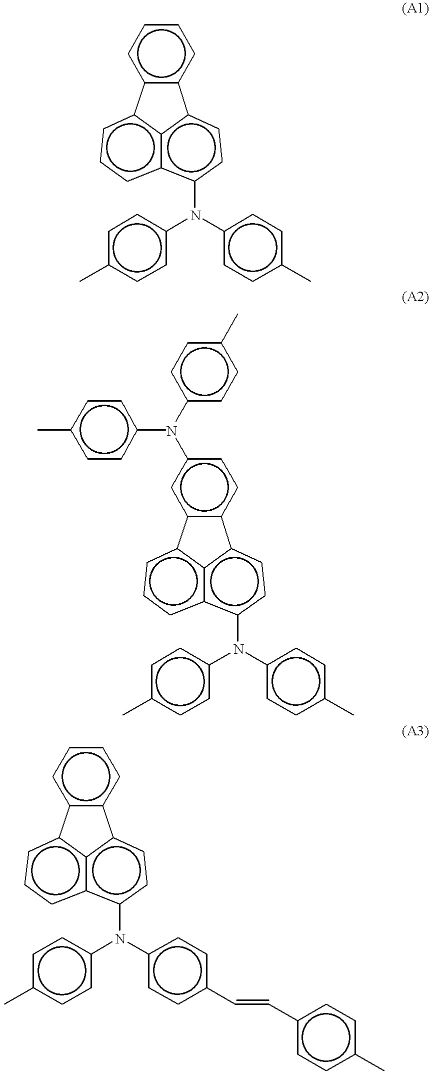

The compound represented by the general formula [II] in the present invention can be synthesized by known methods in the art. For example, a biphenylene compound having a diphenylamino group can be synthesized from an Ullmann reaction of an amine compound having a biphenylene skeleton with an aromatic halogen compound or of a halogen compound having a biphenylene skeleton with an aromatic amine. A styryl derivative can be synthesized using the publicly known Wittig-Horner reaction in the art.

The compounds represented by the general formula [II] in the present invention are shown below with reference to examples that are not intended to limit the invention.

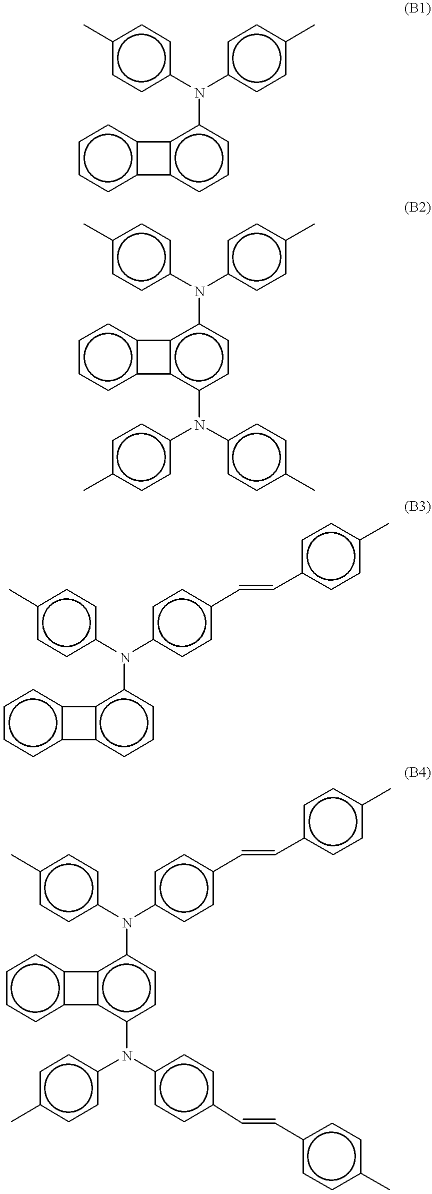

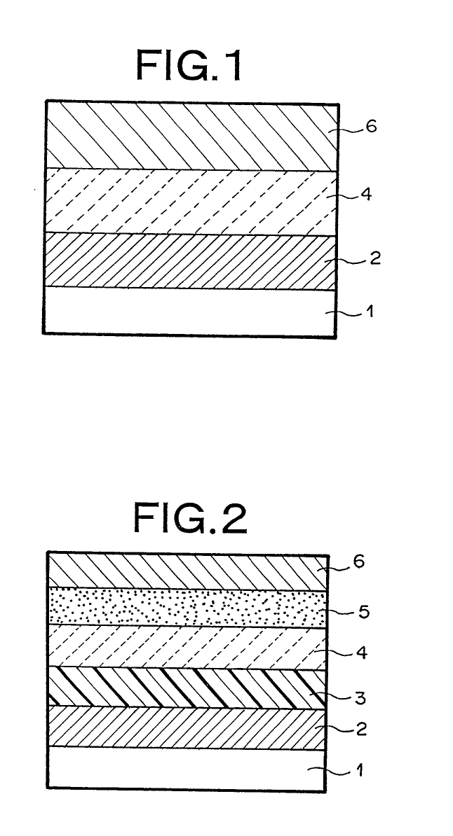

The organic EL device of the present invention has such a device structure that includes a single or two- or more-layered organic thin film laminated between an anode and a cathode. FIGS. 1-4 show examples of the structure that is formed on a substrate, including:

(1) an anode, a luminescent layer and a cathode;

(2) an anode, a hole-transporting layer, a luminescent layer, an electron-transporting layer and a cathode;

(3) an anode, a hole-transporting layer, a luminescent layer and a cathode; or

(4) an anode, a luminescent layer, an electron-transporting layer and a cathode.

The compound represented by the formula [I] or [II] in the present invention may be employed in any one of the above organic layers and may be doped in other hole-transporting material, luminescent material or electron-transporting material.

The hole-transporting materials for use in the present invention are not limited particularly. Any compounds that are commonly employed as hole-transporting materials can be employed. For example, they include the following triphenyldiamines such as bis(di(p-tolyl)aminophenyl)-1,1-cyclohexane [01], N,N′-diphenyl-N,N′-bis(3-methylphenyl)-1,1′-biphenyl-4,4′-diamine [02], and N,N′-diphenyl-N,N′-bis(1-naphthyl)-1,1′-biphenyl-4,4′-diamine [03] and starburst molecules ([04]-[06]).

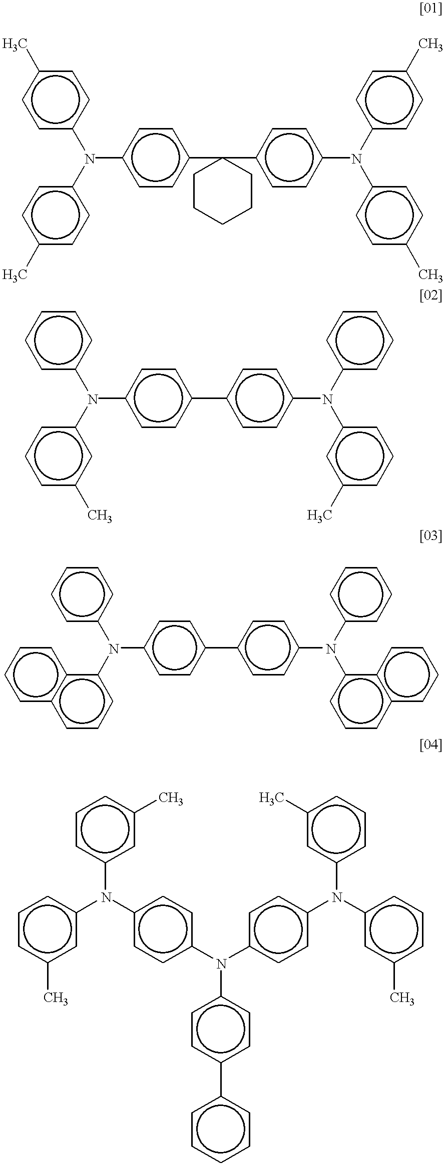

The electron-transporting materials for use in the present invention are not limited particularly. Any compounds that are commonly employed as electron-transporting materials can be employed. For example, they include oxadiazole derivatives such as 2-(4-biphenylyl)-5-(4-t-butylphenyl)-1,3,4-oxadiazole [07] and bis{2-(4-t-butylphenyl)-1,3,4-oxadiazole}-m-phenylene [08], and triazole derivatives ([09) and [10]).

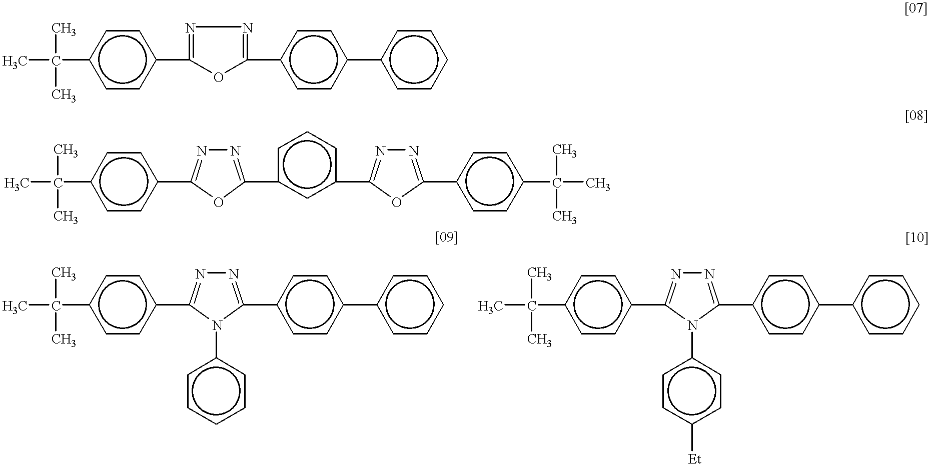

In addition, they also include metal complexes as quinolinol series represented by the general formulae [III], [IV] and [V]. These compounds can be employed as electron transporting luminescent materials.

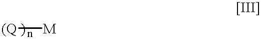

where Q represents a substituted or non-substituted hydroxyquinolin derivative or substituted or non-substituted benzoquinolin derivative; M represents a metal atom; n represents its valance.

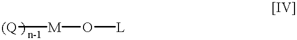

where Q represents a substituted or non-substituted hydroxyquinolin derivative or substituted or non-substituted benzoquinolin derivative; L represents a halogen atom, substituted or non-substituted alkyl group, substituted or non-substituted cycloalkyl group, or substituted or non-substituted aryl group that may contain a nitrogen atom; M represents a metal atom; n represents its valance.

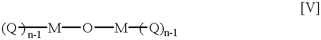

where Q represents a substituted or non-substituted hydroxyquinolin derivative or substituted or non-substituted benzoquinolin derivative; M represents a metal atom; n represents its valance.

Specific examples of the general formula [III] include the following compounds of [11]-[16]:

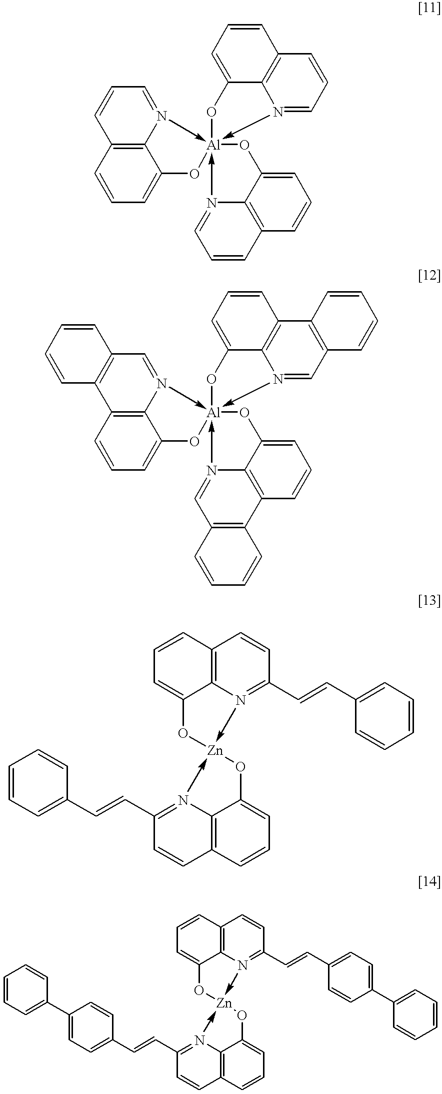

Specific examples of the general formula [IV] include the following compounds of [17]-[22]:

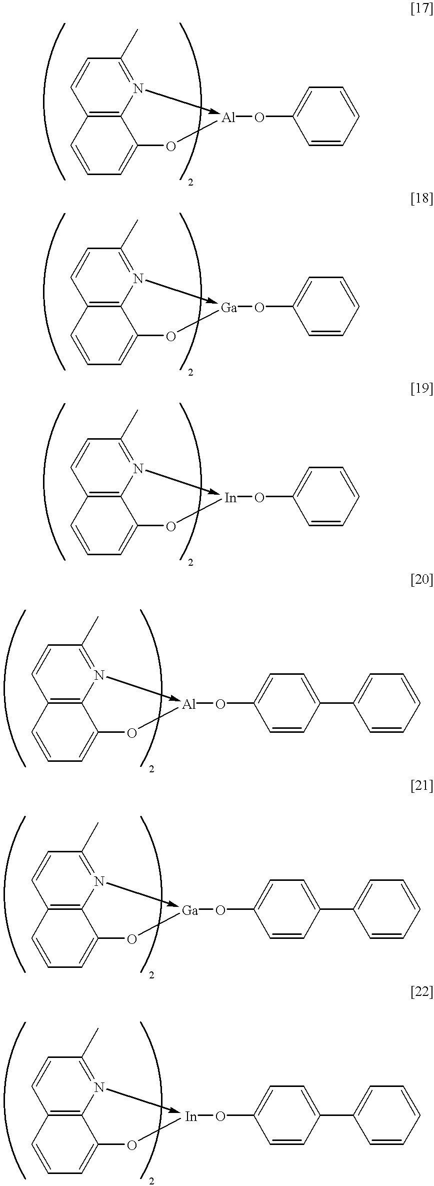

Specific examples of the general formula [V] include the following compounds of [23]-[25]:

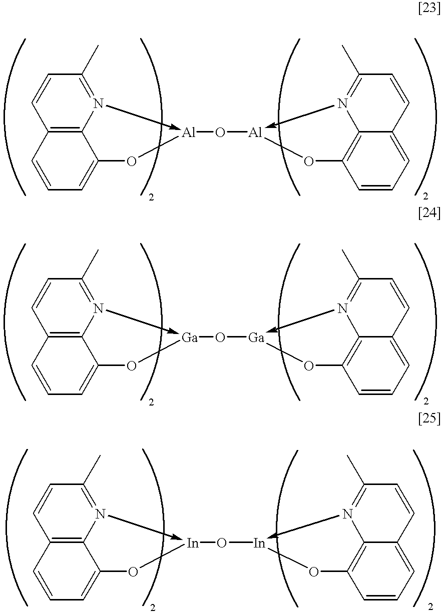

In the structure of the organic EL device of the present invention, the luminescent zone can be constructed with a plurality of layers. In this case, the luminescent material that contains the compound represented by the general formula [I] or [II] in the present invention is employed as a layer that adjoins the anode. In addition, between this layer and the cathode, a further luminescent layer is located. In this case, the compounds represented by (A1)-(A6) or (B1)-(B6) in the present invention can be combined to form the plurality of layers. In addition, to form a luminescent zone with a plurality of luminescent layers between the luminescent layer adjacent to the anode and the cathode, a luminescent layer consisting of the electron-transporting material represented by [07]-[25] mixed with the compound represented by [26]-[29] may be interposed. Alternatively, a luminescent layer consisting of an electron transporting luminescent material such as a compound represented by [30] may be interposed.

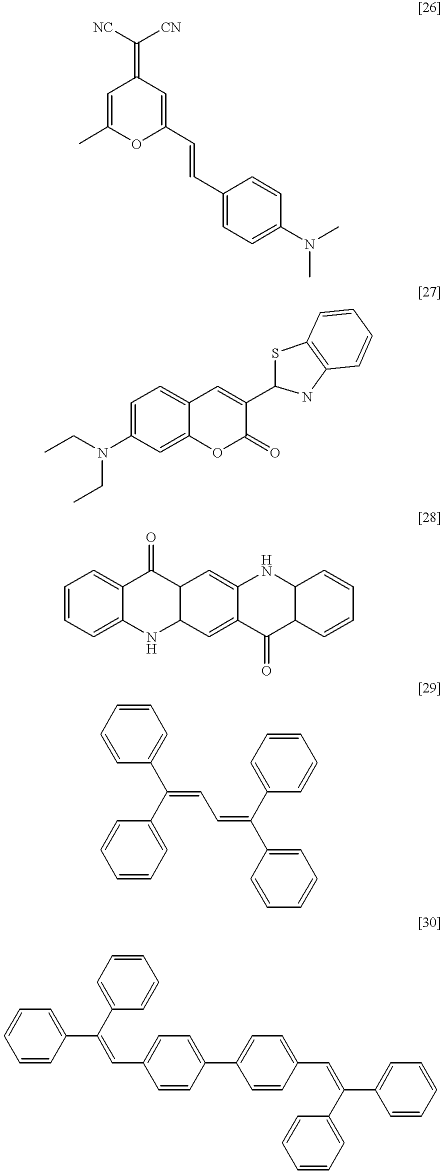

The anode in the organic EL device, playing a role of injecting holes into the hole-transporting layer, is effective if it has a work function of 4.5 eV or more. The anode materials for use in the present invention include indium-tin oxide alloy (ITO), tin oxide (NESA), gold, silver and copper.

For the cathode, to inject electrons effectively into the electron-transporting zone or luminescent layer, materials with smaller work functions than the anode are preferable. The cathode materials are not limited in particular but specifically include indium, aluminum, magnesium, magnesium-indium alloy, magnesium-aluminum alloy, aluminum-lithium alloy, aluminum-scandium-lithium alloy and magnesium-silver alloy.

Methods of forming each layer in the organic EL device of the present invention are not limited in particular. Known vacuum evaporation and spin coating technologies can be employed in the methods of forming. The organic thin film containing the compound represented by the general formula [I] or [II] for use in the organic EL device of the present invention can be formed by the publicly known methods. For example, they include vacuum evaporation, molecular beam evaporation (MBE) and coating technologies such as dipping, spin coating, casting, bar coating or roll coating of a solution solved in a solvent.

In the organic EL device of the present invention, a thickness of each organic layer is not limited in particular. If the thickness is too thin, defects such as pinholes easily occur in general. To the contrary, if it is too thick, it requires a high voltage that reduces efficiency. Therefore, a range between several nm to 1 μm is preferable.

The present invention will be described based on Examples, though it is not limited in the following Examples so long as they can be contained within the gist of the invention.

A synthesis example of the compound represented by the general formula [I] is shown below. Other compounds were synthesized by known methods in the art.

### SYNTHESIS EXAMPLE 1

Fluoranthene and equimolar N-bromosuccinimide are added into a water-sulfuric acid mixed solution (4:1) and stirred for 5 hours at 60° C. A target compound is extracted from the reacted solution using toluene and neutralized with an aqueous solution of 5% sodium hydrogencarbonate. The compound was dried using magnesium sulfate and then the solvent was distilled off to obtain crude crystals, which are re-crystallized from a toluene-hexane mixed solvent to synthesize 3-bromo fluoranthene.

Next, 3-bromofluoranthene, 4-(4-methylstyryl)phenyl-p-tolylamine, potassium carbonate and copper powder are added into a three neck flask and stirred for 30 hours at 200° C. After the reaction, the product was extracted with toluene and toluene layer was washed with water. After it was dried with magnesium sulfate and then the solvent was distilled off, it was subjected to separation-purification by silica gel column chromatography using a toluene-hexane (1:2) mixed solvent to synthesize 3-(4-(4-methylstyryl) phenyl-p-tolylamino)fluoranthene (A3).

A synthesis example of the compound represented by the general formula [II] is shown below. Other compounds were synthesized by known methods in the art.

### SYNTHESIS EXAMPLE 2

Into a chloroform solution of biphenylene, equimolar N-bromosuccinimide and a water-sulfuric acid mixed solution (4:1) are added and stirred for 5 hours at 60° C. A target compound is extracted from the reacted solution using toluene and neutralized with an aqueous solution of 5% sodium hydrogencarbonate. The compound was dried using magnesium sulfate and then the solvent was distilled off to obtain crude crystals, which are re-crystallized from a toluene-hexane mixed solvent to synthesize 1-bromobiphenylene.

Next, 1-bromobiphenylene, 4-(4-methylstyryl)phenyl-p-tolylamine, potassium carbonate and copper powder are added into a three neck flask and stirred for 30 hours at 200° C. After the reaction, the product was extracted with toluene and toluene layer was washed with water. After it was dried with magnesium sulfate and then the solvent was distilled off, it was subjected to separation-purification by silica gel column chromatography using a toluene-hexane (1:2) mixed solvent to synthesize 1-(4-(4-methylstyryl) phenyl-p-tolylamino)biphenylene (B3).

The present invention will be described below with reference to Examples of: the compound represented by the general formula [I] for use in the luminescent layer (EXAMPLES 1-7); a thin film of the compound represented by the general formula [I] mixed with the hole-transporting material for use in the luminescent layer (EXAMPLES 8-10); a thin film of the compound represented by the general formula [I] mixed with the electron-transporting material for use in the luminescent layer (EXAMPLES 11-12); the compound represented by the general formula [I] for use in the hole-transporting layer (EXAMPLES 13-14); and the compound represented by the general formula [I] for use in the electron-transporting layer (EXAMPLE 15).

### EXAMPLE 1

FIG. 1 shows a sectional structure of an organic EL device used in Example 1. This organic EL device comprises an anode 2/luminescent layer 4/cathode 6 formed on a substrate 1.

A procedure of producing the organic EL device according to Example 1 of the present invention is described next.

First, on a glass substrate, a film of ITO is formed using spattering as an anode that has a sheet resistance of 20 Ω/□. On the film, the compound (A1) is formed as a luminescent layer with a thickness of 40 nm using vacuum evaporation. Next, a magnesium-silver alloy is formed as a cathode with a thickness of 200 nm using vacuum evaporation to produce an organic EL device. When a DC voltage of 5 V is applied across the device, a luminescence of 500 cd/m² was obtained.

### EXAMPLE 2

The same operations as Example 1 were performed except for the use of the compound (A2) as a luminescent material to produce an organic EL device. When a DC voltage of 5 V is applied across the device, a luminescence of 1,000 cd/m² was obtained.

### EXAMPLE 3

First, on a glass substrate, a film of ITO is formed using spattering as an anode that has a sheet resistance of 20 Ω/□. On the film, with the use of a chloroform solution of the compound (A2), a luminescent layer with a thickness of 40 nm is formed using spin coating. Next, a magnesium-silver alloy is formed as a cathode with a thickness of 200 nm using vacuum evaporation to produce an organic EL device. When a DC voltage of 5 V is applied across the device, a luminescence of 800 cd/m² was obtained.

### EXAMPLE 4

FIG. 2 shows a sectional structure of an organic EL device used in Example 4. This organic EL device comprises an anode 2/hole-transporting layer 3/luminescent layer 4/electron-transporting layer 5/cathode 6 formed on a substrate 1.

First, on a glass substrate, a film of ITO is formed using spattering as an anode that has a sheet resistance of 20 Ω/□. On the film, N,N′-diphenyl-N,N′-bis(3-methylphenyl)-1,1′-biphenyl-4,4′-diamine [02] is formed as the hole-transporting layer with a thickness of 50 nm using vacuum evaporation. Next, the compound (A3) is formed as the luminescent layer with a thickness of 40 nm using vacuum evaporation. Then, 2-(4-biphenylyl)-5-(4-t-butylphenyl)-1,3,4-oxadiazole [07] is formed as the electron-transporting layer with a thickness of 20 nm using vacuum evaporation. Thereafter, a magnesium-silver alloy is formed as the cathode with a thickness of 200 nm using vacuum evaporation to produce an organic EL device. When a DC voltage of 10 V is applied across the device, a luminescence of 3,000 cd/m² was obtained.

### EXAMPLE 5

The same operations as Example 4 were performed except for the use of N,N′-diphenyl-N,N′-bis(1-naphthyl)-1,1′-biphenyl-4,4′-diamine [03] as the hole-transporting layer, the compound (A4) as the luminescent layer and bis{2-(4-t-butylphenyl)-1,3,4-oxadiazole}-m-phenylene [08] as the electron-transporting layer to produce an organic EL device. When a DC voltage of 10 V is applied across the device, a luminescence of 5,000 cd/m² was obtained.

### EXAMPLE 6

The same operations as Example 4 were performed except for the use of the compound [04] as the hole-transporting layer, the compound (A5) as the luminescent layer and the compound [11] as the electron-transporting layer to produce an organic EL device. When a DC voltage of 10 V is applied across the device, a luminescence of 10,000 cd/m² was obtained.

### EXAMPLE 7

The same operations as Example 4 were performed except for the use of the compound [05] as the hole-transporting layer, the compound (A6) as the luminescent layer and the compound [12] as the electron-transporting layer to produce an organic EL device. When a DC voltage of 10 V is applied across the device, a luminescence of 12,000 cd/m₂ was obtained.

### EXAMPLE 8

FIG. 4 shows a sectional structure of an organic EL device used in Example 8. This organic EL device comprises an anode 2/luminescent layer 4/electron-transporting layer 5/cathode 6 formed on a substrate 1.

First, on a glass substrate, a film of ITO is formed using spattering as an anode that has a sheet resistance of 20 Ω/□. On the film, a thin film of N,N′-diphenyl-N,N′-bis(1-naphthyl)-1,1′-biphenyl-4,4′-diamine [03] and the compound (A3) is formed at a weight ratio of 1:10 as the luminescent layer with a thickness of 50 nm using co-evaporation. Next, the compound [09] is formed as the electron-transporting layer with a thickness of 50 nm using vacuum evaporation. Then, a magnesium-silver alloy is formed as a cathode with a thickness of 200 nm using vacuum evaporation to produce an EL device. When a DC voltage of 10 V is applied across the device, a luminescence of 2,200 cd/m² was obtained.

### EXAMPLE 9

The same operations as Example 8 were performed except for the use of the compound (A5) instead of the compound (A3) to produce an organic EL device. When a DC voltage of 10 V is applied across the device, a luminescence of 5,300 cd/m² was obtained.

### EXAMPLE 10

First, on a glass substrate, a film of ITO is formed using spattering as an anode that has a sheet resistance of 20 Ω/□. On the film, the luminescent layer with a thickness of 40 nm is formed by spin coating using a chloroform solution containing the compound (A4) and N,N′-diphenyl-N,N′-bis(1-naphthyl)-1,1′-biphenyl-4,4′-diamine [03] at a molar ratio of 1:10. Next, the compound [10] is formed as the electron-transporting layer with a thickness of 50 nm using vacuum evaporation. On the layer, a magnesium-silver alloy is formed as the cathode with a thickness of 200 nm using vacuum evaporation to produce an EL device When a DC voltage of 10 V is applied across the device, a luminescence of 4,300 cd/m² was obtained.

### EXAMPLE 11

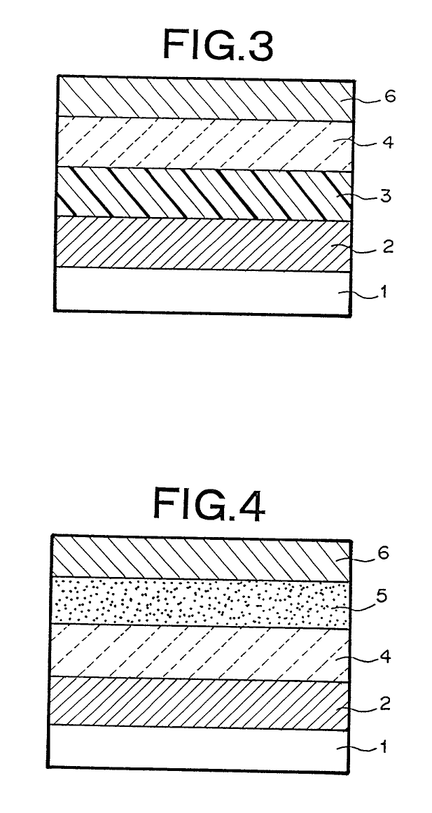

FIG. 3 shows a sectional structure of an organic EL device used in Example 11. This organic EL device comprises an anode 2/hole-transporting layer 3/luminescent layer 4/cathode 6 formed on a substrate 1.

First, on a glass substrate, a film of ITO is formed using spattering as an anode that has a sheet resistance of 20 Ω/□. On the film, N,N′-diphenyl-N,N′-bis(1-naphthyl)-1,1′-biphenyl-4,4′-diamine [03] is formed as the hole-transporting layer with a thickness of 50 nm using vacuum evaporation. Next, a film of the compound [11] and the compound (A5) at a weight ratio of 20:1 is formed as the luminescent layer with a thickness of 50 nm using vacuum co-evaporation. Then, a magnesium-silver alloy is formed as the cathode with a thickness of 200 nm to produce an EL device. When a DC voltage of 10 V is applied across the device, a luminescence of 4,500 cd/m² was obtained.

### EXAMPLE 12

The same operations as Example 11 were performed except for the use of N,N′-diphenyl-N,N′-bis(3-methylphenyl)-1,1′-biphenyl-4,4′-diamine [02] as the hole-transporting layer and a film formed from vacuum co-evaporation of the compound [13] and the compound (A5) at a weight ratio of 20:1 as the luminescent layer to produce an organic EL device. When a DC voltage of 10 V is applied across the device, a luminescence of 3,700 cd/m² was obtained.

### EXAMPLE 13

The same operations as Example 11 were performed except for the use of the compound (A5) as the hole-transporting layer and the compound [13] as the luminescent layer to produce an organic EL device. When a DC voltage of 10 V is applied across the device, a yellow luminescence of 4,000 cd/m² was obtained.

### EXAMPLE 14

The same operations as Example 11 were performed except for the use of the compound (A6) as the hole-transporting layer to produce an organic EL device. When a DC voltage of 10 V is applied across the device, a yellow luminescence of 4,500 cd/m² was obtained.

### EXAMPLE 15

The same operations as Example 11 were performed except for the use of N,N′-diphenyl-N,N′-bis(1-naphthyl)-1,1′-biphenyl-4,4′-diamine [03] as the hole-transporting layer, the compound [13] as the luminescent layer, and the compound (A6) as the electron-transporting layer to produce an organic EL device. When a DC voltage of 10 V is applied across the device, a yellow luminescence of 2,500 cd/m² was obtained.

The organic EL devices described in the above Examples 1-15 were all found to have half-lives of 5,000 hours or more of brightness when they are continuously driven from an initial brightness of 100 cd/m².

The present invention will be further described with reference to Examples of: the compound represented by the general formula [II] for use in the luminescent layer (EXAMPLES 16-22); a thin film of the compound represented by the general formula [II] mixed with the hole-transporting material for use in the luminescent layer (EXAMPLES 23-25); a thin film of the compound represented by the general formula [II] mixed with the electron-transporting material for use in the luminescent layer (EXAMPLES 26-27); the compound represented by the general formula [II] for use in the hole-transporting layer (EXAMPLES 28-29); and the compound represented by the general formula [II] for use in the electron-transporting layer (EXAMPLE 30).

### EXAMPLE 16

FIG. 1 shows a sectional structure of an organic EL device used in Example 16. This organic EL device comprises an anode 2/luminescent layer 4/cathode 6 formed on a substrate 1.

First, on a glass substrate, a film of ITO is formed using spattering as an anode that has a sheet resistance of 20 Ω/□. On the film, the compound (B1) is formed as the luminescent layer with a thickness of 40 nm using vacuum evaporation. Next, a magnesium-silver alloy is formed as the cathode with a thickness of 200 nm using vacuum evaporation to produce an organic EL device. When a DC voltage of 5 V is applied across the device, a luminescence of 5,000 cd/m² was obtained.

### EXAMPLE 17

The same operations as Example 16 were performed except for the use of the compound (B3) as a luminescent material to produce an organic EL device. When a DC voltage of 5 V is applied across the device, a luminescence of 1,200 cd/m² was obtained.

### EXAMPLE 18

First, on a glass substrate, a film of ITO is formed using spattering as an anode that has a sheet resistance of 20 Ω/□. On the film, with the use of a chloroform solution of the compound (B3), a luminescent layer with a thickness of 40 nm is formed using spin coating. Next, a magnesium-silver alloy is formed as a cathode with a thickness of 200 nm using vacuum evaporation to produce an organic EL device. When a DC voltage of 5 V is applied across the device, a luminescence of 1,000 cd/m² was obtained.

### EXAMPLE 19

FIG. 2 shows a sectional structure of an organic EL device used in Example 19. This organic EL device comprises an anode 2/hole-transporting layer 3/luminescent layer 4/electron-transporting layer 5/cathode 6 formed on a substrate 1.

First, on a glass substrate, a film of ITO is formed using spattering as an anode that has a sheet resistance of 20 Ω/□. On the film, N,N′-diphenyl-N,N′-bis(3-methylphenyl)-[1,1′-biphenyl]-4,4′-diamine [02] is formed as the hole-transporting layer with a thickness of 50 nm using vacuum evaporation. Next, the compound (B3) is formed as the luminescent layer with a thickness of 40 nm using vacuum evaporation. Then, 2-(4-biphenylyl)-5-(4-t-butylphenyl)-1,3,4-oxadiazole [07] is formed as the electron-transporting layer with a thickness of 20 nm using vacuum evaporation. Thereafter, a magnesium-silver alloy is formed as the cathode with a thickness of 200 nm using vacuum evaporation to produce an organic EL device. When a DC voltage of 10 V is applied across the device, a luminescence of 2,500 cd/m² was obtained.

### EXAMPLE 20

The same operations as Example 19 were performed except for the use of N,N′-diphenyl-N,N′-bis(1-naphthyl)-1,1′-biphenyl-4,4′-diamine [03] as the hole-transporting layer, the compound (B4) as the luminescent layer and bis{2-(4-t-butylphenyl)-1,3,4-oxadiazole}-m-phenylene [08] as the electron-transporting layer to produce an organic EL device. When a DC voltage of 10 V is applied across the device, a luminescence of 7,000 cd/m² was obtained.

### EXAMPLE 21

The same operations as Example 19 were performed except for the use of the compound [04] as the hole-transporting layer, the compound (B5) as the luminescent layer and the compound [11] as the electron-transporting layer to produce an organic EL device. When a DC voltage of 10 V is applied across the device, a luminescence of 9,500 cd/m² was obtained.

### EXAMPLE 22

The same operations as Example 19 were performed except for the use of the compound [05] as the hole-transporting layer, the compound (B6) as the luminescent layer and the compound [12] as the electron-transporting layer to produce an organic EL device. When a DC voltage of 10 V is applied across the device, a luminescence of 13,000 cd/m² was obtained.

### EXAMPLE 23

FIG. 4 shows a sectional structure of an organic EL device used in Example 23. This organic EL device comprises an anode 2/luminescent layer 4/electron-transporting layer 5/cathode 6 formed on a substrate 1.

First, on a glass substrate, a film of ITO is formed using spattering as an anode that has a sheet resistance of 20 Ω/□. On the film, a thin film of N,N′-diphenyl-N,N′-bis(1-naphthyl)-1,1′-biphenyl-4,4′-diamine [03] and the compound (B3) is formed at a weight ratio of 1:10 as the luminescent layer with a thickness of 50 nm using co-evaporation. Next, the compound [09] is formed as the electron-transporting layer with a thickness of 50 nm using vacuum evaporation. Then, a magnesium-silver alloy is formed as the cathode with a thickness of 200 nm using vacuum evaporation to produce an EL device. When a DC voltage of 10 V is applied across the device, a luminescence of 1,200 cd/m² was obtained.

### EXAMPLE 24

The same operations as Example 23 were performed except for the use of the compound (B5) instead of the compound (B3) to produce an organic EL device. When a DC voltage of 10 V is applied across the device, a luminescence of 4,300 cd/m² was obtained.

### EXAMPLE 25

First, on a glass substrate, a film of ITO is formed using spattering as an anode that has a sheet resistance of 20 Ω/□. On the film, the luminescent layer with a thickness of 40 nm is formed by spin coating using a chloroform solution containing the compound (B5) and N,N′-diphenyl-N,N′-bis(1-naphthyl)-1,1′-biphenyl-4,4′-diamine [03] at a molar ratio of 1:10. Next, the compound [10] is formed as the electron-transporting layer with a thickness of 50 nm using vacuum evaporation. On the layer, a magnesium-silver alloy is formed as the cathode with a thickness of 200 nm using vacuum evaporation to produce an EL device. When a DC voltage of 10 V is applied across the device, a luminescence of 3,500 cd/m² was obtained.

### EXAMPLE 26

FIG. 3 shows a sectional structure of an organic EL device used in Example 26. This organic EL device comprises an anode 2/hole-transporting layer 3/luminescent layer 4/cathode 6 formed on a substrate 1.

First, on a glass substrate, a film of ITO is formed using spattering as an anode that has a sheet resistance of 20 Ω/□. On the film, N,N′-diphenyl-N,N′-bis(1-naphthyl)-1,1′-biphenyl-4,4′-diamine [03] is formed as the hole-transporting layer with a thickness of 50 nm using vacuum evaporation. Next, a film is formed as the luminescent layer with a thickness of 50 nm from the compound [11] and the compound (B3) at a weight ratio of 20:1 using vacuum co-evaporation. Then, a magnesium-silver alloy is formed as the cathode with a thickness of 200 nm to produce an EL device. When a DC voltage of 10 V is applied across the device, a luminescence of 2,500 cd/m² was obtained.

### EXAMPLE 27

The same operations as Example 26 were performed except for the use of N,N′-diphenyl-N,N′-bis(3-methylphenyl)-[1,1′-biphenyl]-4,4′-diamine [02] as the hole-transporting layer and a film formed from vacuum co-evaporation of the compound [13] and the compound (B5) at a weight ratio of 20:1 as the luminescent layer to produce an organic EL device. When a DC voltage of 10 V is applied across the device, a luminescence of 3,700 cd/m² was obtained.

### EXAMPLE 28

The same operations as Example 26 were performed except for the use of the compound (B5) as the hole-transporting layer and the compound [13] as the luminescent layer to produce an organic EL device. When a DC voltage of 10 V is applied across the device, a yellow luminescence of 4,000 cd/m² was obtained.

### EXAMPLE 29

The same operations as Example 26 were performed except for the use of the compound (B6) as the hole-transporting layer to produce an organic EL device. When a DC voltage of 10 V is applied across the device, a yellow luminescence of 4,500 cd/m² was obtained.

### EXAMPLE 30

The same operations as Example 19 were performed except for the use of N,N′-diphenyl-N,N′-bis(1-naphthyl)-1,1′-biphenyl-4,4′-diamine [03] as the hole-transporting layer, the compound [13] as the luminescent layer, and the compound (B6) as the electron-transporting layer to produce an organic EL device. When a DC voltage of 10 V is applied across the device, a yellow luminescence of 2,500 cd/m² was obtained.

The organic EL devices described in the above Examples 16-30 were all found to have half-lives of 5,000 hours or more of brightness when they are continuously driven from an initial brightness of 100 cd/m².

Having described the embodiments consistent with the invention, other embodiments and variations consistent with the invention will be apparent to those skilled in the art. Therefore, the present invention should not be viewed as limited to the disclosed embodiments but rather should be viewed as limited only by the spirit and scope of the appended claims.

What is claimed is:

1. An organic electroluminescent device comprising one or more organic thin film layer(s) containing a luminescent layer placed between an anode and a cathode, wherein at least one layer of said organic thin film contains a compound represented by the following general formula [I] in the form of a single substance or a mixture containing the same: 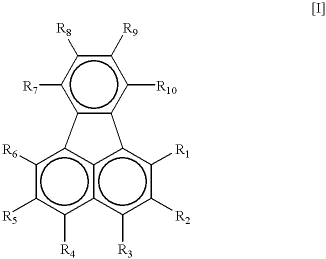
wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

2. The organic electroluminescent device according to claim 1, wherein at least one of Ar₁ and Ar₂ in said compound represented by the general formula [I] has a substituted or non-substituted styryl group as a substituent.

3. The organic electroluminescent device according to claim 1, wherein-said at least one organic thin film layer comprising said compound represented by general formula [I] is a hole-transporting layer.

4. The organic electroluminescent device according to claim 1, wherein said at least one organic thin film layer comprising said compound represented by general formula [I] is a hole-transporting layer, and wherein at least one of Ar₁ and Ar₂ in said compound represented by the general formula [I] has a substituted or non-substituted styryl group as a substituent.

5. The organic electroluminescent device according to claim 1, wherein said at least one organic thin film layer comprising said compound represented by general formula [I] is a electron-transporting layer.

6. The organic electroluminescent device according to claim 1, wherein said at least one organic thin film layer comprising said compound represented by general formula [I] is a electron-transporting layer, and wherein at least one of Ar₁ and Ar₂ in said compound represented by the general formula [I] has a substituted or non-substituted styryl group as a substituent.

7. An organic electroluminescent device comprising at least an anode, an organic luminescent zone and a cathode as constituents, wherein the luminescent zone being formed one or more organic thin film layer(s), characterized in that said luminescent zone is adjacent to the anode, and a layer adjacent to the anode of the organic layer(s) forming the luminescent zone contains a compound expressed in following general formula [I] in the form of a single substance or a mixture containing the same: 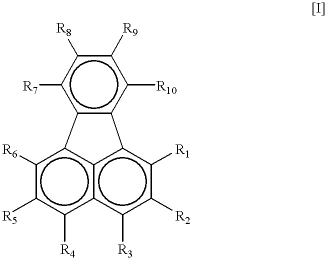
wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

8. The organic electroluminescent device according to claim 7, wherein at least one of Ar₁ and Ar₂ in said compound represented by the general formula [I] has a substituted or non-substituted styryl group as a substituent.

9. An organic electroluminescent device comprising one or more organic thin film layer(s) containing a luminescent layer placed between an anode and a cathode, wherein at least one layer of said organic thin film contains a compound represented by the following general formula [II] in the form of a single substance or a mixture containing the same: 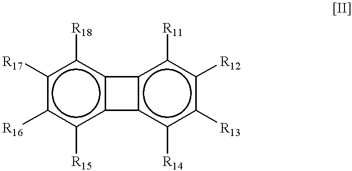
wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

10. The organic electroluminescent device according to claim 1, wherein at least one of Ar₁ and Ar₂ in said compound represented by the general formula [II] has a substituted or non-substituted styryl group as a substituent.

11. The organic electroluminescent device according to claim 1, said at least one organic thin film layer comprising said compound represented by general formula [II] is a hole-transporting layer.

12. The organic electroluminescent device according to claim 1, wherein said at least one organic thin film layer comprising said compound represented by general formula [II] is a hole-transporting layer, and wherein at least one of Ar₁ and Ar₂ in said compound represented by the general formula [II] has a substituted or non-substituted styryl group as a substituent.

13. The organic electroluminescent device according to claim 1, wherein said at least one organic thin film layer comprising said compound represented by general formula [II] is a electron-transporting layer.

14. The organic electroluminescent device according to claim 1, wherein said at least one organic thin film layer comprising said compound represented by general formula [II] is a electron-transporting layer, and wherein at least one of Ar₁ and Ar₂in said compound represented by the general formula [II] has a substituted or non-substituted styryl group as a substituent.

15. An organic electroluminescent device comprising at least an anode, an organic luminescent zone and a cathode as constituents, wherein the luminescent zone being formed one or more organic thin film layer(s), characterized in that said luminescent zone is adjacent to the anode, and a layer adjacent to the anode of the organic layer(s) forming the luminescent zone contains a compound expressed in following general formula [II] in the form of a single substance or a mixture containing the same: 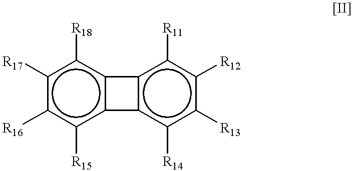
wherein each of R₁-R₁₀ independently represent a hydrogen atom, halogen atom, hydroxyl group, substituted or non-substituted amino group, nitro group, cyano group, substituted or non-substituted alkyl group, substituted or non-substituted alkenyl group, substituted or non-substituted cycloalkyl group, substituted or non-substituted alkoxy group, substituted or non-substituted aromatic hydrocarbon group, substituted or non-substituted aromatic heterocycle group, substituted or non-substituted aralkyl group, substituted or non-substituted aryloxy group, substituted or non-substituted alkoxycarbonyl group, or carboxyl group; at least one of R₁-R₁₀ is a diarylamino group represented by —NAr₁Ar₂ (Ar₁ and Ar₂ each independently represent a substituted or non-substituted aryl group having 6-20 carbon atoms); and two of R₁-R₁₀ may form a ring.

16. The organic electroluminescent device according to claim 7, wherein at least one of Ar₁ and Ar₂ in said compound represented by the general formula [II] has a substituted or non-substituted styryl group as a substituent.
